(19) United States
(12) Patent Application Publication
(10) Pub. No.: US 2003/0097207 A1
(43) Pub. Date: May 22, 2003

(54) Process and device for activating a motor vehicle accessory

(75) Inventors: Hans-Peter Landgraf, Gauting (DE); Josef Riedmaier, Pentenried (DE)

Correspondence Address: NIXON PEABODY, LLP, 8180 GREENSBORO DRIVE, SUITE 800, MCLEAN, VA, 22102, US

(73) Assignee: Webasto Thermosyteme International GmbH, Stockdorf (DE)

(21) Appl. No.: 10/280,094

(22) Filed: Oct. 25, 2002

(30) Foreign Application Priority Data
Oct. 26, 2001 (DE) 101 52 444.7

(51) Int. Cl. G06F 17/00

(52) U.S. Cl. 701/2; 701/36

(57) ABSTRACT

A process for activating a motor vehicle accessory (12), especially an auxiliary motor vehicle heater, and device for controlling the motor vehicle accessory (12) in which the activation commands for the motor vehicle accessory are input into a control part (10) which has control keys (11), an operating system, application software (16) which is specific to the activation of the motor vehicle accessory, a display (15) which also serves as an activation surface, and a data transmission interface (18), the activation commands are processed into activation data in the control part using the application software, the activation data are transmitted via the data transmission interface of the control part to the data transmission interface (21) of a base station (20) and are converted there into radio signals, the radio signals obtained in this way are output via a radio interface (22) and are transmitted to a radio remote control remote terminal (25) in the motor vehicle (13), and the motor vehicle accessory is activated by the radio remote control according to the activation commands which have been input into the control part.

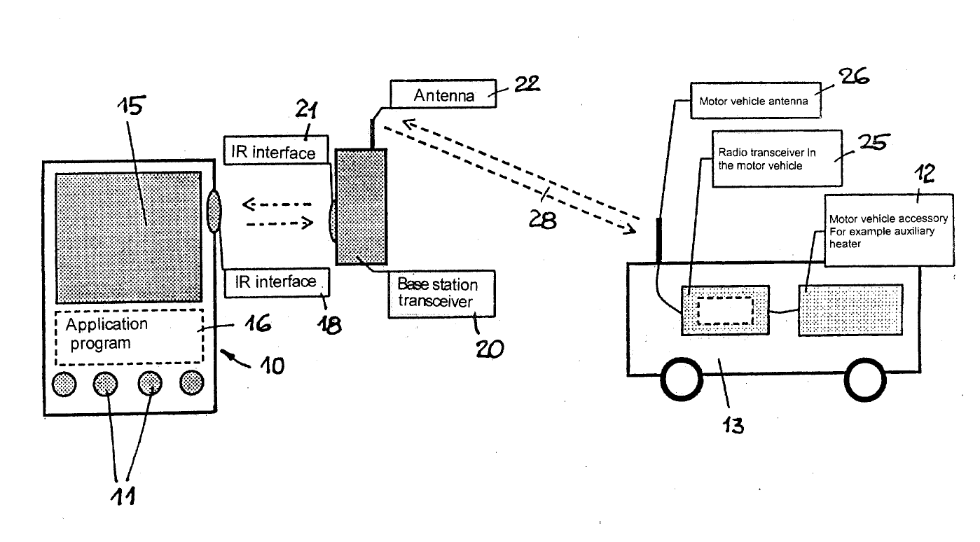

### BACKGROUND OF THE INVENTION

1. Field of the Invention

The invention relates to a process and a device for activating a motor vehicle accessory, especially an auxiliary motor vehicle heater.

2. Description of Related Art

Pre-select clocks or timers which make it possible to activate or deactivate motor vehicle accessories at a given, pre-selected time without the operator needing to be in or at the vehicle at this pre-selected time are known. The respective activation time and optionally other characteristics of the motor vehicle accessory can be determined by means of such a timer. However, the disadvantage is that the operator can only set and reset the timer from the vehicle.

Published German Patent Application DE 195 48 548 A1 discloses an accessory of a motor vehicle, for example, in the form of an auxiliary heater, which can be activated by a telecontrol system, in which a receiver installed in the motor vehicle can be connected to transmit signals wirelessly to a mobile transmitter in the form of remote control. The mobile receiver is connected to the control device of the accessory by means of a signal line. The control device is furthermore connected to a time-programmable means for activation of the accessory. The remote control is externally similar to a conventional remote control for television sets, video recorders or the like, but is designed as an input unit for the time-programmable means. It especially has controls for programming of at least one starting time. Due to the small size of the remote control, the number and execution of the control measures and any display measures are very limited. Complicated control sequences cannot be expected of the operator. Therefore it is difficult or impossible by means of remote control to induce more complex actions than, for example, simple activation or deactivation of operation of the motor vehicle accessory.

The same or similar limitation must be tolerated if, in the conventional manner, (German Patent DE 42 27 658 C1 and published German Patent Application DE 195 52 658 A1) the input devices for remote controls are handsets or mobile phones.

The object of this invention is to devise a process and a device for activating a motor vehicle accessory, especially an auxiliary motor vehicle heater, which allows especially convenient operation by the user and also make even complicated control sequences accessible to technically less sophisticated operators.

With regard to the process aspect, this object is achieved in accordance with the invention by a process for activating a motor vehicle accessory, especially an auxiliary motor vehicle heater, in which the activation commands for the motor vehicle accessory are input into a control part which has control keys, an operating system, application software which is specific to the activation of the motor vehicle accessory, a display for the activation surface and a data transmission interface, the activation commands are processed in the control part, using the application software, into activation data which are transmitted via the data transmission interface of the control part to the data transmission interface of a base station and are converted there into radio signals, the radio signals obtained in this way are output via a radio interface and are transmitted to a radio remote control remote terminal in the motor vehicle, and the motor vehicle accessory is activated by the radio remote control according to the activation commands which have been input into the control part.

The device of the invention for controlling a motor vehicle accessory, especially an auxiliary motor vehicle heater, is provided with a control part which has control keys for input of activation commands for the motor vehicle accessory, an operating system, application software which is specific to the activation of the motor vehicle accessory, a display for the activation surface, a data transmission interface and a unit for processing of activation commands using the application software into activation data, and with a base station which has a data transmission interface which can be coupled to the data transmission interface of the control part for transmitting the activation data from the control part to the base station, a unit for converting the activation data into radio signals and a function interface which can be coupled wirelessly to a radio remote control remote terminal in the motor vehicle for receiving the radio signals and for activating the motor vehicle accessory according to the activation commands which have been input into the control part.

The process and the device of the invention combine, in a surprisingly simple and effective manner, the advantages of a very comfortable timer which is easy to operate with the advantages of radio remote control. The activation surface of the control part implemented here via the operating system and application software makes it possible in a clear and simple manner, for example, to fix the desired activation time, the activation interval and the type of desired comfort function for the motor vehicle.

In particular, a PC, a laptop, a palmtop, an organizer or a combination of organizer and mobile phone can be used as the control part. These devices are commercially available; it is common to them that they have an operating system which is easy to operate.

By means of the application software, preferably a surface for comfortable activation of the motor vehicle accessory is made available on the control part.

In the simplest case, the base station can be part of a conventional radio remote control, with a data transmission interface, preferably an infrared interface, and a software part for conversion of the activation data into secure radio telegrams added.

Signals can be transmitted via the data transmission interfaces between the control part and the base station, and wirelessly between the base station and the motor vehicle unidirectionally or bi-directionally. In the latter case, data can also be transmitted from the motor vehicle via the base station to the control part, especially measured values and/or state information of the motor vehicle accessory.

The activation data can be converted directly into radio signals after input of the activation commands, and can be transmitted wirelessly to the remote terminal in the motor vehicle. This mode of operation has the advantage that, on the display of the control part, the reaction of the motor vehicle accessory or the remote terminal in the motor vehicle can be clearly and comfortably displayed. Moreover, in this case, a conventional radio transceiver need be expanded only by a data transmission interface, preferably an infrared interface, in order to form the base station.

However, the activation commands, or the activation data derived from them, can also be buffered first in the base station and transmitted only at a given activation instant wirelessly to the remote terminal in the motor vehicle. In this mode of operation, the instant of transmission coincides with the activation instant. In this way, on the display of the control part, it can only be displayed that the activation request has arrived at the base station and has been understood.

In the device in accordance with the invention, the base station can have control knobs which enable a conventional remote control function for the motor vehicle accessory.

One embodiment of the invention is explained in detail below with reference to the drawings.

### BRIEF DESCRIPTION OF THE DRAWINGS

The sole FIGURE is a block diagram of a device for controlling a motor vehicle accessory in which there is bi-directionality both for an infrared and also the radio link.

### DETAILED DESCRIPTION OF THE INVENTION

This control device has a control part 10 which is provided with control keys 11 for inputting activation commands for an accessory 12, for example, an auxiliary heater, in a motor vehicle 13, and with a display 15. The control part 10 is, for example, a conventional palmtop or organizer, has an operating system which is easy to operate, for example, the operating system “Pocket PC 2002”®. It is equipped with application software which is specific to the activation of the motor vehicle accessory and which is schematically shown at 16. The application software 16 provides, among other things, for a convenient activation surface on the display 15. The laptop or organizer which forms the control part 10, furthermore, has a bi-directional infrared interface 18, and furthermore, contains a unit which processes the activation commands which have been input via the control keys 11 using application software 16 for activation data for the accessory 12.

The control device also includes a base station 20 which, in the simplest case, can be part of conventional radio remote control with a radio transceiver to which a bi-directional infrared interface 21 and a corresponding software part is added. The infrared interface 21 of the base station 20 communicates with the infrared interface 18 of the control part 10, among other things, to transmit the activation data from the control part to the base station 20. The base station 20 contains a unit for converting the activation data into radio signals and it has a radio interface in the form of an antenna 22. The base station 20 can furthermore be provided with control knobs which enable a conventional remote control function for the motor vehicle accessory 12.

The arrangement in the vehicle 13 can be the same as in the case of a conventional remote control of motor vehicle accessories. It has a radio remote control remote terminal 25 with a radio transceiver and a radio interface in the form of a motor vehicle antenna 26. The base station 20 and the remote terminal 25 communicate with one another via a radio link 28.

Two embodiments of the illustrated control device are explained below.

In a first embodiment, the operator establishes, for example, the desired activation instant, the desired activation interval and the type of desired comfort function for the motor vehicle 13 using the surface shown on the display 15 of the control part 10. The data necessary for this purpose are processed in the control part 10 and then relayed to the base station 20 via the infrared interface 18. There, the data are translated into the correspondingly secure radio telegrams and are sent via the radio interface 22 directly to the radio remote control remote terminal 25 in the motor vehicle 13. This can take place, for example, over a distance of a few hundred meters. The radio remote control remote terminal 25 receives the data, and it can, for its part, relay the commands intended for the accessory 12 at the activation instant which has been predetermined by the operator on the control part 10 to the accessory.

In a second embodiment, the transmission path can be the same as in the first embodiment. The difference from the first embodiment is that data are first buffered in the base station 20 and only sent to the remote terminal 25 in the vehicle 13 at the intended activation instant via the radio link 28. Thus, the vehicle-side remote terminal 25 is relieved because it need not buffer the data sent before the activation instant until the intended activation instant.

If the two embodiments are compared to one another, it can be established that the first embodiment has the advantage that the reaction of the motor vehicle accessory 12 and/or the vehicle-side remote terminal 25 can be displayed clearly and conveniently on the display 15. Another advantage of the version according to the first embodiment is that, to form the base station 20, the radio transceiver of a conventional radio remote control need be expanded only by the infrared interface 18.

In the case of the second embodiment, the instant of sending coincides with the activation instant. As a result, it can simply be displayed on the base station 20 or the display 15 of the control part 10 that an activation request for the motor vehicle accessory 12 has arrived and was understood there. Therefore, the use of extensive optical and optionally also acoustic signaling possibilities such as offered by the first embodiment can be omitted. Furthermore, it can be necessary in the second embodiment for the base station 20 to be stationary in order to ensure that, at the intended activation instant, radio contact between the base station 20 and the motor vehicle-side remote terminal 25 can in fact be established. This is less critical in the first embodiment because, there, the operator can immediately monitor the success of the activation request by the completed acknowledgement.

One sample handling sequence with use of the first embodiment is explained below, for example, in turn, there being the following components:

The control part 10 is a palmtop with a bidirectional infrared interface 18.

The base station 20 is a radio transceiver with a bi-directional infrared interface 21 added, and with an antenna 22.

The remote terminal 25 in the motor vehicle 13 is a radio transceiver with a motor vehicle antenna 26.

The motor vehicle accessory 12 is an auxiliary heater with an auxiliary ventilation function.

Operation is as follows;

On the palmtop 10, the operator retrieves the application “auxiliary heating/auxiliary ventilation.” The activation instant, the type of activation, “heating” or “ventilation,” and the activation interval are set using the palmtop 10. For all actions, stipulated values can be offered and used by the operator. The user surface is designed to be easily understandable for this purpose and intuitively operable. This facilitates all settings.

Upon pressing the button, the activation request is sent with all activation parameters via the base station 20 and the radio link 28 to the remote terminal 25 in the motor vehicle 13.

In the remote terminal 25, the parameters of the activation request are evaluated. Thereupon all settings which correspond to the activation parameters are completed, and the timers of the remote terminal 25 and/or the auxiliary heater 12 are set accordingly.

Then, readiness for executing the activation request is reported by the terminal station 25 to the base station 20 and by the base station 20 to the palmtop 10. On the operator surface of the palmtop 10, all information on the status of the auxiliary heater 12 and the pre-select parameters appears. Therefore, the operator knows that the activation request has arrived at the motor vehicle 13, and can check the operator surface of the palmtop 10 at any time to review what action and time activation time has been pre-selected.

The palmtop 10 can be carried by the user. The base station 20 can likewise be made so small that it can be used as a normal manual transmitter as in conventional radio remote controls, i.e., it can easily constitute a radio remote control manual transmitter with an infrared interface 21 and information processing software added.

A proper sequence takes place when the operator initiates interrogation of status data, measured values and faulty information.

The base station 20 can be made differently. In particular, the base station 20 can be built as a docking station which is equipped with an infrared interface 21 and which temporarily holds a radio transceiver and the palmtop which has the infrared interface 18 or the like. Such a design is preferred for the above described second embodiment. The infrared interface 21 can also be provided directly on the radio transceiver of the base station 20, as is explained above for the first embodiment.

Instead of the described infrared interfaces 18, 21, basically, also the serial interface present on most computers and the like can be used. However, then, a connecting cable is necessary between the control part 10 and the base station 20.

What is claimed is:

1. Process for activating a motor vehicle accessory comprising the steps of:
inputting activation commands for the motor vehicle accessory into a control part which has control keys, an operating system, application software which is specific to the activation of the motor vehicle accessory, a display and a data transmission interface;
processing the activation commands into activation data in the control part using the application software;
transmitting the activation data via the interface of the control part to a data transmission interface of a base station;
converting the activation data into radio signals in the base station,
outputting the radio signals via a radio interface and transmitting the radio signals to a radio remote control remote terminal in a motor vehicle, and
activating the motor vehicle accessory by the radio remote control according to the activation commands which have been input into the control part.

2. Process as claimed in claim 1, wherein a PC, laptop or palmtop is used as the control part.

3. Process as claimed in claim 1, wherein an organizer or a combination organizer and mobile phone is used as the control part.

4. Process as claimed in claim 1, wherein said inputting step is performed using said display by means of the application software.

5. Process as claimed in claim 1, wherein at least one part of a radio remote control with a data transmission interface and a software part for conversion of the activation data into secure radio telegrams is used as said base station.

6. Process as claimed in claim 1, wherein the signals are transmitted unidirectionally between the control part and the base station via the data transmission interfaces, and wherein the signals are transmitted unidirectionally between the base station and the motor vehicle via the radio link.

7. Process as claimed in claim 1, wherein the signals are transmitted bi-directionally between the control part and the base station via the data transmission interfaces, and wherein the signals are transmitted bi-directionally between the base station and the motor vehicle via the radio link.

8. Process as claimed in claim 7, wherein the signals are bi-directionally transmitted between the base station and the vehicle via the radio link, and wherein data are also transmitted from the vehicle via the base station to the control part.

9. Process as claimed in claim 8, wherein at least one of measured values and stated information about the motor vehicle accessory are included in the data transmitted from the motor vehicle via the base station to the control part.

10. Process as claimed in claim 1, wherein immediately after said inputting of the activation commands, the activation data are converted into radio signals and are transmitted via the radio link to the remote terminal in the motor vehicle.

11. Process as claimed in claim 10, wherein the reaction of at least one of the remote terminal in the motor vehicle and of the motor vehicle accessory to the activation data is displayed on the display of the control part.

12. Process as claimed in claim 1, wherein at least one of the activation commands and the activation data derived from the activation commands are buffered in the base station and then are transmitted only at a given activation time via the radio link to the remote terminal in the motor vehicle.

13. Process as claimed in claim 12, wherein the signals are transmitted bi-directionally between the control part and the base station via the data transmission interfaces; wherein the signals are transmitted bi-directionally between the base station and the motor vehicle via the radio link; and wherein the fact that the activation request has arrived at the base station and has been understood is displayed on the display of the control part.

14. Process as claimed in claim 1, wherein data transmission place between the control part and the base station is performed via infrared interfaces.

15. Process as claimed in claim 1, wherein the motor vehicle accessory controlled is a motor vehicle auxiliary motor vehicle heater

16. Device for controlling a motor vehicle auxiliary motor vehicle heater, comprising:
a control part which has control keys for inputting activation commands for the motor vehicle accessory, an operating system, application software which is specific to the activation of the motor vehicle accessory, a display for the activation surface, a data transmission interface and a unit for processing the activation commands into activation data using the application software, and
a base station which has a data transmission interface for receiving activation data from the data transmission interface of the control part, a unit for converting the activation data into radio signals and a radio interface;
a remote terminal of a radio remote control in the motor vehicle for receiving the radio signals from the radio interface of the base station via a via a radio link and for activating the motor vehicle accessory according to the activation commands input into the control part.

17. Device as claimed in claim 16, wherein the control part comprises one of a PC, laptop and palmtop.

18. Device as claimed in claim 16, wherein the control part comprises one of an organizer and a combination organizer and mobile phone.

19. Device as claimed in claim 16, wherein the base station is part of a radio remote control with a data transmission interface and a software part for conversion of the activation data into secure radio telegrams.

20. Device as claimed in claim 16, wherein infrared interfaces are provided for data transmission between the control part and the base station.

21. Device as claimed in claim 16, wherein the base station has control knobs for performing remote control operation of the motor vehicle accessory.

22. Device as claimed in claim 16, wherein the motor vehicle accessory is an auxiliary motor vehicle heater.
